(19) United States
(12) Patent Application Publication
(10) Pub. No.: US 2023/0347633 A1
(43) Pub. Date: Nov. 2, 2023

(54) Polyester Terephthalate Rigid Wadding Disposed Between Surface Laminations

(71) Applicants: Salvatore J. Cardinale, Mill Valley, CA (US); Max Cardinale, Mill Valley, CA (US)

(72) Inventors: Salvatore J. Cardinale, Mill Valley, CA (US); Max Cardinale, Mill Valley, CA (US)

(21) Appl. No.: 18/217,567

(22) Filed: Jul. 1, 2023

Related U.S. Application Data
(63) Continuation-in-part of application No. 15/442,526, filed on Feb. 24, 2017, now Pat. No. 11,691,402.
Application No. 15/442,526 is a continuation-in-part of application No. 17/686,944, filed on Mar. 4, 2022.
Application No. 17/686,944 is a continuation-in-part of application No. 16/394,583, filed on Apr. 25, 2019, now Pat. No. 11,267,640.
(60) Provisional application No. 62/299,471, filed on Feb. 24, 2016.
(60) Provisional application No. 63/181,854, filed on Apr. 29, 2021.

(51) Int. Cl. B32B 27/12; B32B 27/08; B32B 37/06; B32B 27/36

(52) U.S. Cl. CPC B32B 27/12; B32B 27/08; B32B 37/065; B32B 27/36; B32B 2250/03; B32B 2262/0284; B32B 2307/702; B32B 2250/244

(57) ABSTRACT

Wadding, insulation and packaging for food and other products is made of pure homogeneous polyester terephthalate (PET) that satisfies the resin recycling identification code number “1”. For purposes of protecting an inner wadding or other insulation, one or more film strips or film coatings may be applied by the artful use of amorphous (non-crystalized) PET or other types or configurations of PET, such that a filmstrip and/or wadding melts at a lower temperature and can act as a thermal bond adhesive. The film strips or film coatings may be made of homogeneous polyester terephthalate (PET) made of pure PET.

### CROSS-REFERENCE TO RELATED APPLICATIONS

This utility patent application is a Continuation in Part (CIP) of patent application Ser. No. 15/442,526 filed on Feb. 24, 2017 which claims the benefit and priority of application 62/299,471 filed on Feb. 24, 2016.

This utility patent application is a CIP of patent application Ser. No. 17/686,944 filed on Mar. 4, 2022 which claims the benefit of provisional patent application 63/181,854 filed on Apr. 4, 2021. Patent application Ser. No. 17/686,944 is a CIP of patent application Ser. No. 16/394,583 filed on Apr. 25, 2019, now U.S. Pat. No. 11,267,640.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Such trademark(s) may include “Renewliner.”

### BACKGROUND OF THE INVENTIONS

### (1) Field of the Invention

Disclosed embodiments include the manufacture and/or use of recyclable materials fabricated for ease of insertion into a typical box. Disclosed embodiments include the use of polyester fill which may have one or more sides covered with a film component.

Some disclosed embodiments overcome shortfalls in the art by using polyester type materials that often achieve a number “1” value for recycling.

Disclosed embodiments may be comprised of pure or near pure resin or more common material such as recycled bottles and other recycled polymers, polyesters, polypropylenes and similar materials. Such recycled materials may have a “1” recycling value with such a value sometimes defined as an object made of PET or PETE (Polyethylene Terephthalate). The body of the PET insulation may comprise a wadding structure. The wadding structure may be covered with a layer of film. The film may comprise PET in either a non-crystalized form other form. A layer of film may be bonded by use of heat or other means. In some applications, both sides of a PET wadding structure may be covered with PET film.

Disclosed embodiments generally relate to compostable. repulpable and/or biodegradable insulation systems. More particularly, the invention relates to means and methods of creating insulation for use in boxes and other packaging or containers, with the insulation comprising seeds, being useful for growing crops, flower and other plants.

Disclosed embodiments generally relate to foldable insulation systems. More particularly, the invention relates to means and methods of creating compostable repulpable, biodegradable insulation, sometimes embedded with seeds for use in transportation, boxes and other packaging or containers, with the insulation sometimes taking a sleeve configuration or box configuration.

### (2) Description of the Related Art

The known related art fails to anticipate or disclose the principles of the present inventions:

U.S. Pat. No. 11,078,007 generally discloses the use of PET for insulation, but requires insulation to be made of “primarily” of PET, resulting in the use of non PET elements, destroying the recyclability of products conforming to the '007 patent.

U.S. Published Patent Application US2005/0189404 by Xiaobai et al discloses an insulation panel system that comports to boxes. But, the Xiaobai system fails to provide a shipping sleeve or to fold to a flat state for storage.

In the related art, U.S. Pat. No. 5,269,602 issued to Kuwahara et al on Dec. 14, 1993 discloses a thermal insulation box wherein thermal insulation material is injected into wall compartments. Kuwahara fails to provide a sleeve type structure or practical means of recycling or retrieving insulation components.

U.S. Pat. No. 2,998,337 issued to Tillotson on Aug. 29, 1961 discloses a reflective and fibrous type of insulation made of mineral wool and similar materials. The insulation of Tillotson does not fold well into a box and has not sleeve type configuration. Moreover, the Tillotson insulation is not recyclable.

U.S. Published Patent Application No. 20110253773 by Lozier and published on Oct. 20, 2011 discloses an insulated pizza box. The pizza box of Lozier fails to provide means of manufacture or use of a separate insulation piece that may be used as a shipping sleeve.

U.S. Published Patent Application No. 20080260303 by De Lesseux et al discloses an insulated shipping bag with an insert system. Unfortunately, the bag and insert are not well suited for traditional shipping in boxes or other closed containers.

U.S. Pat. No. 5,129,519 issued to David et al on Jul. 14, 1992 discloses a packaging container with inner and outer walls. Unfortunately, David container fails to provide insulation upon or near the six sides of a traditional container and fails to provide a sleeve type configuration.

Thus, there is a long felt need in the art for the present invention.

### BRIEF SUMMARY OF THE INVENTION

Disclosed embodiments overcome shortfalls in the related art by providing a compostable and/or biodegradable insulation product that is well suited for perishable goods. When the disclosed embodiments become unusable, they may be placed upon the ground and used for growing plants such as flowers or crops. Disclosed embodiments may be imbedded with seeds and/or seeds may be placed upon the insulation in a planting process.

Disclosed embodiments overcome shortfalls in the related art by providing insulation that is rich in plant nutrients and insulation value.

Disclosed embodiments overcomes shortfalls in the related art by presenting an unobvious and unique combination and configuration of methods and components to create a compostable and/or biodegradable, flexible and versatile insulation structure that is well suited for both the rigors of shipping and for planting and nurturing plants.

Disclosed embodiments overcome shortfalls in the related art by, inter alia, providing insulation material that holds moisture so as to work well as seed starter. The disclosed embodiments include truly “biodegradable” insulation materials as defined in the most stringent definitions of “biodegradable.”

Materials used in fabricating disclosed insulation compositions include, recycled cardboard, resulting in an organic craft color, starch, green fiber, and be repulpable, recyclable, reusable and configurable in many thicknesses with a preferred thickness in the range of a quarter of an inch to one and a half inches.

Disclosed embodiments may include preferred densities of one to two pounds per cubic foot. Disclosed embodiments may be used for food bearing seeds and may eschew the use of bleached cardboard so as to maintain and organic craft paper color.

Disclosed embodiments overcome shortfalls in the related art by providing a recyclable and/or compostable, repulpable seed embedded insulation configured in a unique seam and cut formation such that the disclosed embodiments may act has both an insulation sleeve and provide a rapid deployment for expansion to insulate traditional boxes and/or other enclosures.

Disclosed embodiments may also take the form of shippable enclosures or containers ready for immediate placement into soil after the contents have been emptied.

Some disclosed embodiments overcome shortfalls in the related art by providing flat storage, ease of manufacture and a composition of pure recyclable material.

Some disclosed embodiments overcome shortfalls in the related art by presenting an unobvious and unique combination and configuration of methods and components to create a recyclable, flexible and versatile insulation structure that is well suited for on demand sleeve insulation and rapid expansion for insertion into shipping boxes and other containers.

Some disclosed embodiments overcome shortfalls in the related art by using recyclable materials fabricated for ease of insertion into a typical box. Disclosed embodiments include the use of polyester fill encased or covered with a clear membrane or other surface material.

Some disclosed embodiments overcome shortfalls in the art by using polyester type materials that often achieve a number “1” value for recycling. Disclosed embodiments may be comprised of virgin and/or recycled resin or more common material such as recycled bottles and other recycled polymers, polyesters, polypropylenes and similar materials.

Some disclosed embodiments overcome shortfalls in the art by providing a relatively flat insulation member that may be disposed or attached to the top of a box or other container. The disclosed box wings may be fastened downwardly to further secure the workpiece.

These and other objects and advantages will be made apparent when considering the following detailed specification when taken in conjunction with the drawings.

### BRIEF DESCRIPTION OF THE DRAWINGS

FIG. 1 is a perspective view of a reusable and/or plantable container in an upright position

FIG. 2 is a perspective view of a reusable and/or plantable container in an flat position

FIG. 3 is a perspective view of sheets of a reusable and/or plantable container

FIG. 4 depicts two reusable and/or plantable containers

FIG. 5 depicts disclosed insulation with embedded seeds

FIG. 6 depicts disclosed seed embedded insulation with a cover sheet

FIG. 7 depicts raw fiber material suitable for the manufacture of insulation that may be embedded with seeds

FIG. 8 depicts disclosed insulation in a covered treatment

FIG. 9 depicts a top view of a disclosed embodiment in a flat or sleeve configuration

FIG. 10 depicts an isometric view of a disclosed embodiment in a partially open position

FIG. 11 depicts an isometric view of a disclosed embodiment in a partially open position

FIG. 12 depicts an isometric view of a disclosed embodiment in a free standing position with box wings in a flat position

FIG. 13 depicts an isometric view of a disclosed embodiment in a free standing position with box wings in a flat position

FIG. 14 depicts an isometric view of a disclosed embodiment in a free standing position with box wings in a flat position

FIG. 15 depicts an isometric view of a disclosed embodiment with box wings retracted and the embodiment partially disposed within a box

FIG. 16 depicts an isometric view of a disclosed embodiment with box wings retracted and fully disposed within a box

FIG. 17 depicts a laminate system

### REFERENCE NUMERALS IN THE DRAWINGS

50 compostable. repulpable and/or biodegradable insulated envelope/sheet system with embedded seeds
55 compostable. repulpable biodegradable insulation and/or insulation pulp
57 raw fiber material sometimes used to make sheets and/or compostable repulpable biodegradable insulation
60 top ends of envelope sheets with means of closure
65 vertical seam of envelope 50
67 compostable repulpable biodegradable sheets sometimes embedded with seeds
68 seeds embedded into a sheet 67 or insulation pulp
70 bottom fold of envelope or container 50
72 bottom end of sheets 67
80 compostable. repulpable biodegradable insulation covered in sheets 67 or other covering
100 reusable/plantable sleeve embodiment in general
110 box wing void
120 lower fold assembly
125 bottom fold
130 box wing
140 upper fixed seam
150 upper edges
160 upper void defined by the upper edges 150
200 outer container
300 laminate system
310 first film of a laminate system
330 rigid wadding of a laminate system
340 second film of a laminate system

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

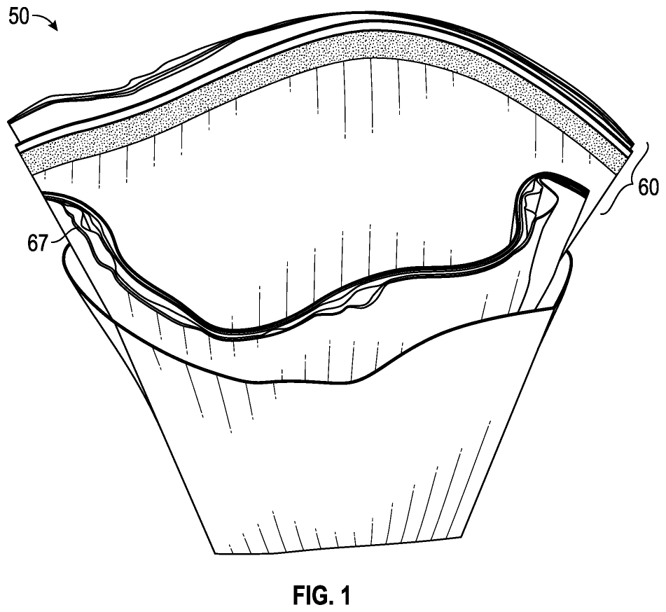

FIG. 1 depicts a reusable and/or plantable container 50 in an upright position. The container may comprise seeds and may comprise an upper section having means of closure 60 such as organic adhesives disposed upon closure strips. Plantable containers 50 may further comprise a plurality of compostable repulpable biodegradable sheets 67 sometimes embedded with seeds. A plantable container may be flexible and act as a liner disposed within a box or used as a stand-alone product.

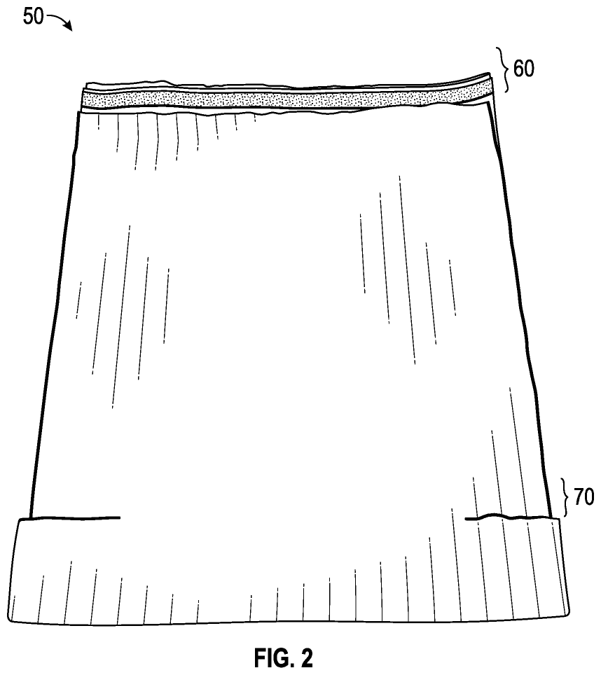

FIG. 2 depicts a plantable container 50 having closure strips 60 and a bottom fold 70 of sheets. The bottom fold may be secure be organic closure systems such as adhesive strips.

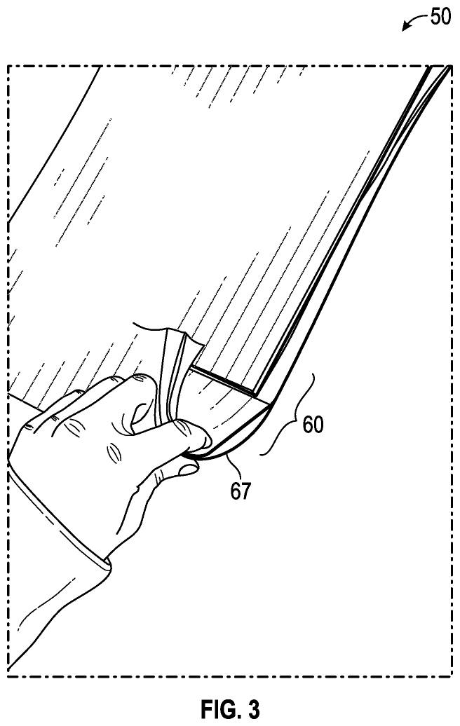

FIG. 3 depicts a top end of a plantable container 50 having means of closure and comprising a plurality of disclosed sheets 67.

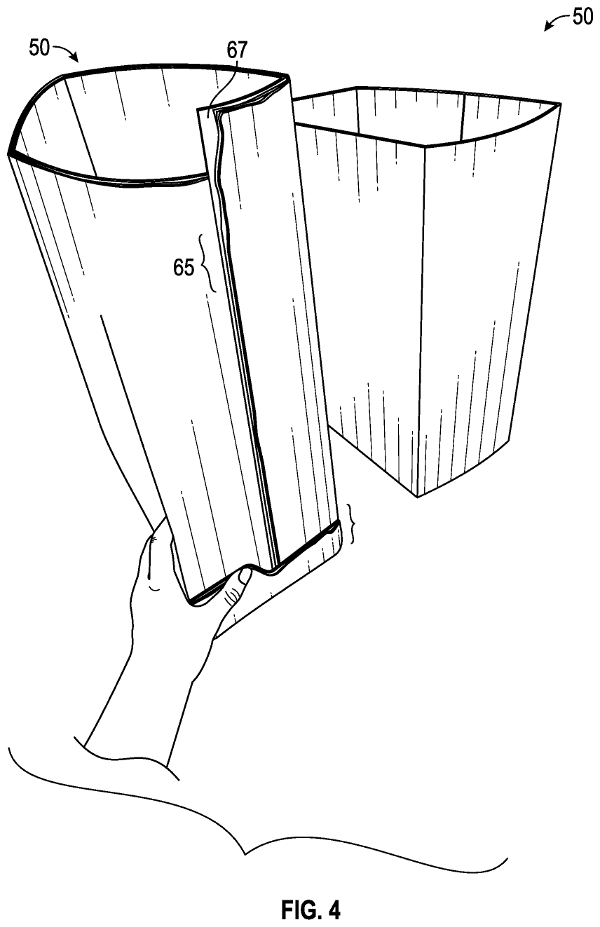

FIG. 4 depicts two plantable containers 50 with a container in the foreground comprising a vertical seam 65.

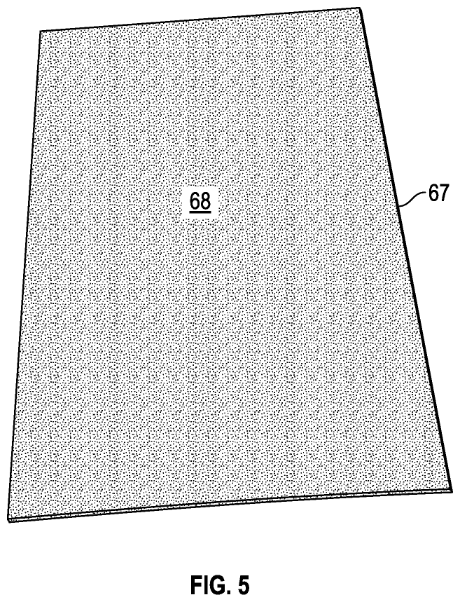

FIG. 5 depicts a sample of disclosed insulation with said insulation taking many forms. For example, insulation may be embedded with seeds 68, such as food bearing seeds. Insulation may be compostable. repulpable and/or biodegradable. Insulation may draw moisture from the air and hold moisture so as to assist in growing seeds that may be embedded within the insulation.

Materials used in fabricating disclosed insulation compositions include, recycled cardboard, resulting in an organic craft color, starch, green fiber. Insulation may be repulpable, recyclable, reusable and configurable in many thicknesses with a preferred thickness in the range of a quarter of an inch to one and a half inches.

Insulation may comport to preferred densities of one to two pounds per cubic foot.

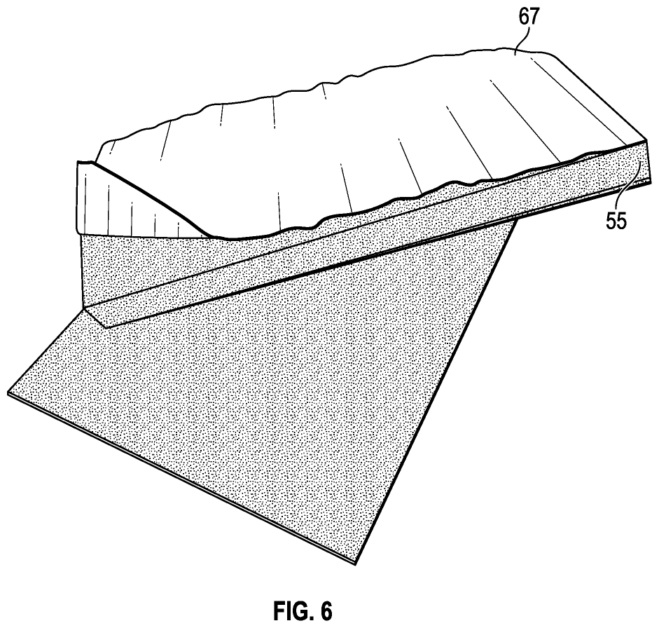

FIG. 6 depicts disclosed seed embedded insulation 55 with a cover sheet 67. A cover or cover sheet 67 may be a starch applied by heat and by the spraying of water or other fluid.

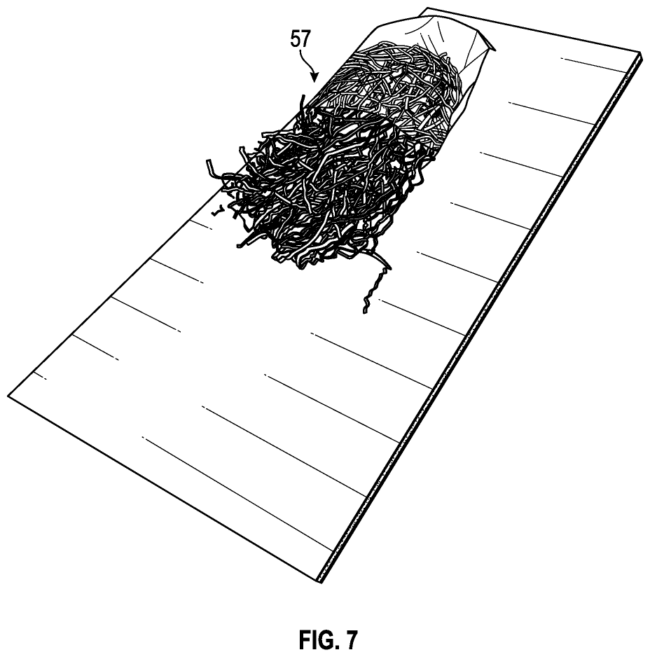

FIG. 7 depicts raw and sometimes shredded material used for insulation that may include recycled and brown cardboard. Bleached cardboard is not desirable.

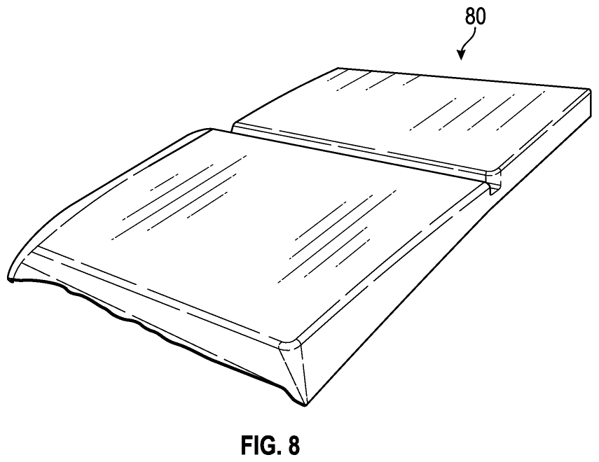

FIG. 8 depicts insulation in incapsulated covering.

Embedded seeds may have certain size restrictions in comparison to the machinery making the insulation. In one disclosed embodiment, seeds are disposed at or near the surface of insulation to better preserve the insulation making equipment. Disclosed embodiments may be 100 percent curb side recyclable.

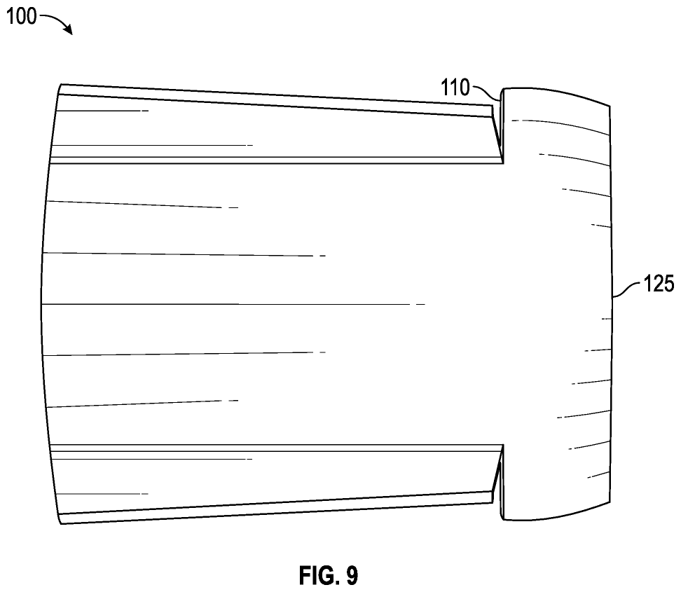

FIG. 9 depicts a disclosed embodiment 100 disposed in a compact or folded position and having a pair of box wing voids 110 or cuts. The box wing voids 110 are defined by lower sections of the embodiment. The lower sections of the embodiment may include a bottom fold. In an unfolded position, the bottom fold flattens and may be disposed in the bottom of a container or box.

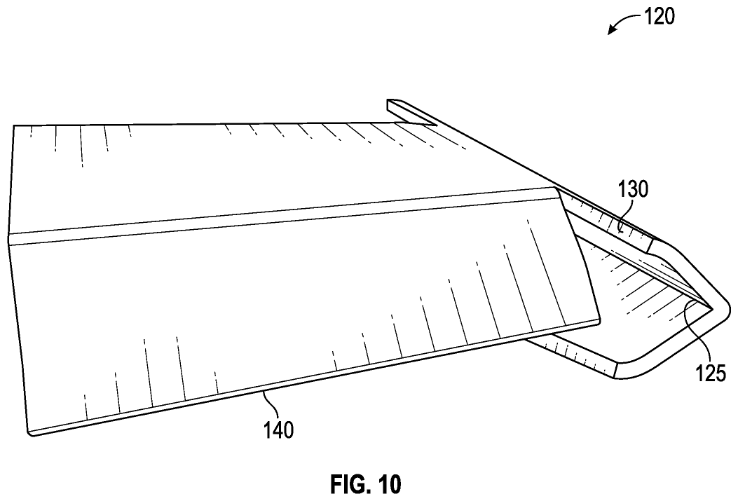

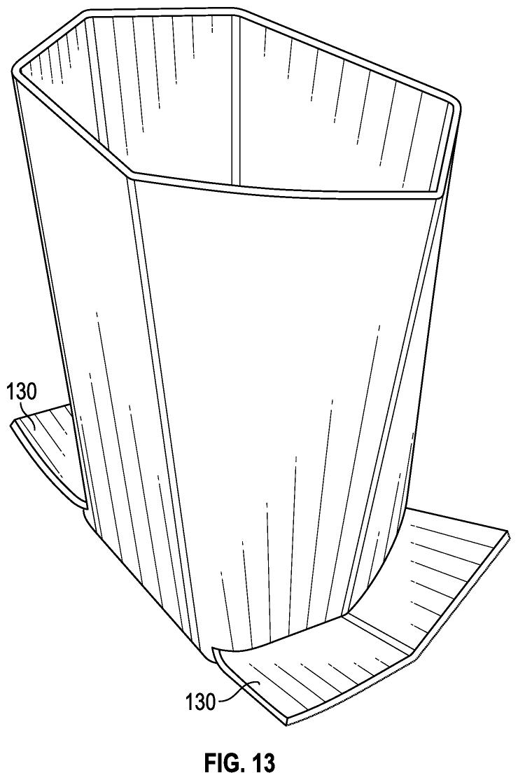

FIG. 10 depicts a disclosed embodiment comprising a lower fold assembly 120 with the lower fold assembly comprising a bottom fold 125. The bottom fold assembly in conjunction with the bottom fold 125 and box wing void 110 (shown in FIG. 9) may comprise a pair of box wings 130 (as shown in FIG. 13)

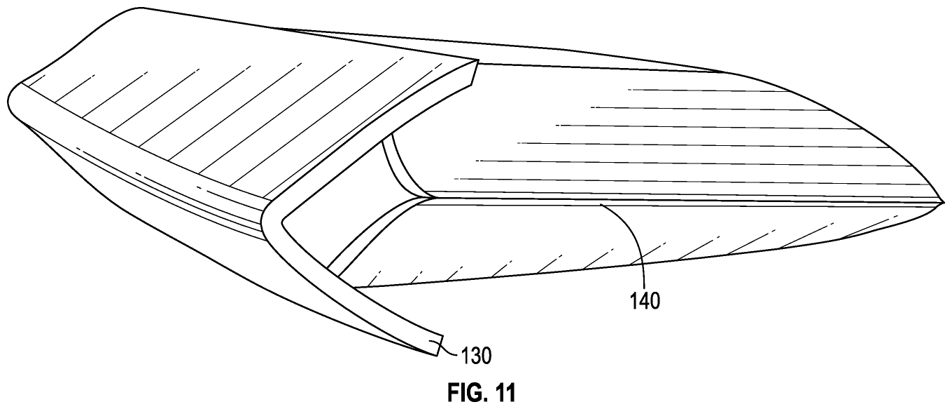

FIG. 11 depicts a disclosed embodiment comprising a partially opened box wing 130 and an upper fixed seam.

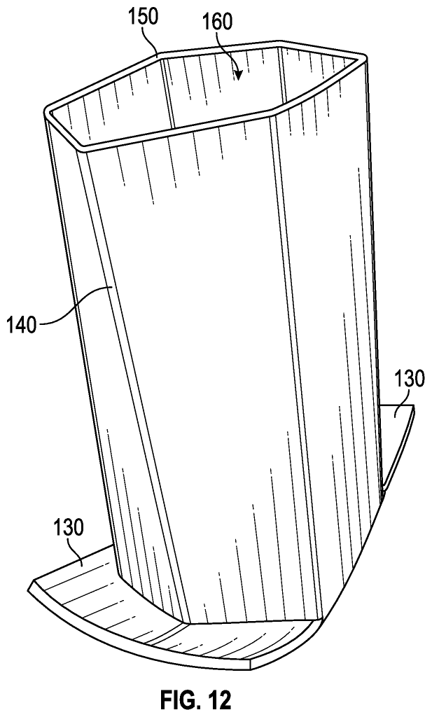

FIG. 12 depicts a disclosed embodiment comprising an upper void 160 defined by upper edges 150. The upper void 160 expands as the embodiment is expanded from a sleeve position to a box configuration. A disclosed embodiment may have two upper seams 140 that may span from the upper edges 140 to the box wing void. In a self-supporting position, two box wings 130 may be disposed in a flat position in a plane perpendicular to the main body or upper seams of the device.

FIG. 13 depicts a rotated view of FIG. 12 and further depicts two box wings 130 in an opened or expanded position, prior to insertion into a container.

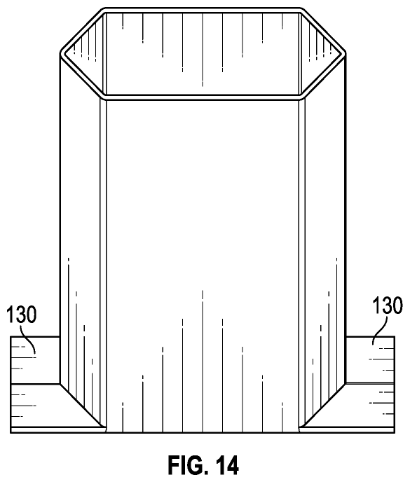

FIG. 14 depicts a disclosed embodiment showing two box wings 130 on either side with the box wings ready to be folded into a box or other container.

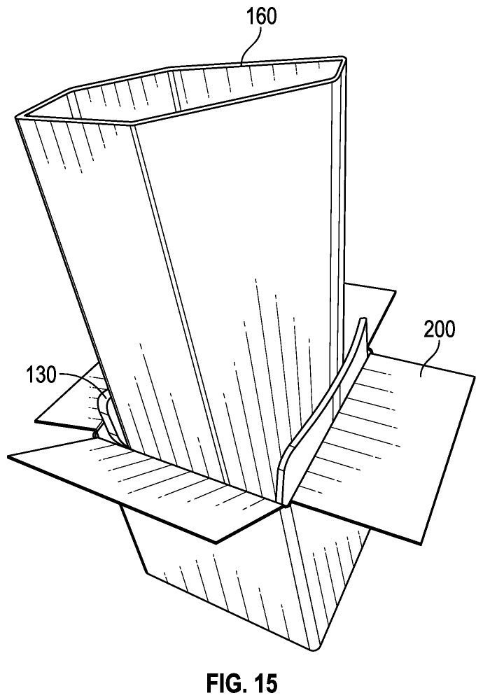

FIG. 15 depicts a box 200 or other container receiving a disclosed embodiment having two folded box wings 130 and an open upper void 160.

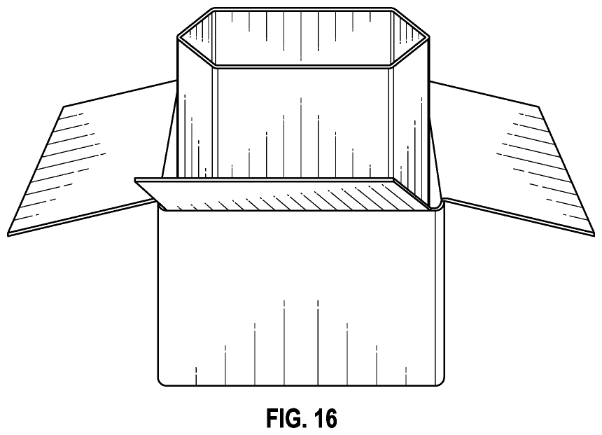

FIG. 16 depicts a disclosed embodiment fully inserted into a box.

With respect to the void that helps to define the box wing, the slot may be half of the width of the box. Since a 5 inch slot will equal a 10 inch wing, the approximate size of the box. If cut shorter, a gusset may be formed that will allow the sleeve to hold a small amount of fluid. Such fluid would remain in the box so long as the box is approximately level. The thickness of the insulation may be made of any thickness. Other proportions are subject to change to comport with the needs of the shipper and/or container.

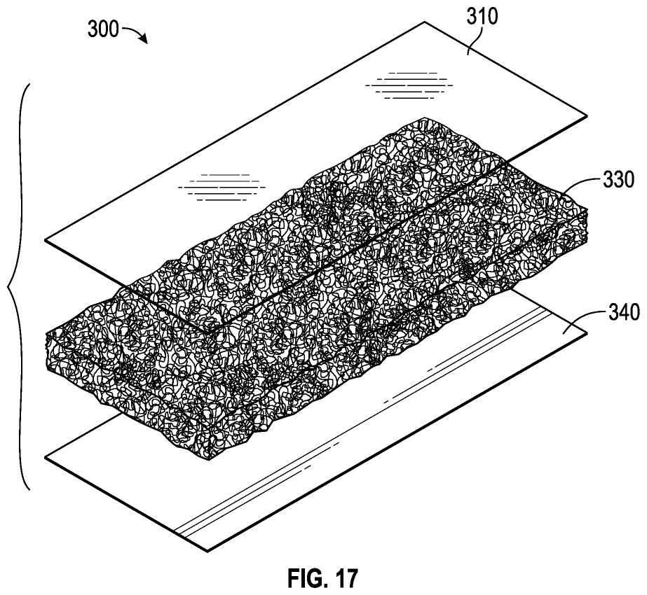

FIG. 17 depicts a wadding system 300, which sometimes may be considered a rigid wadding system, is shown with a first film 310 attached to a wadding structure 330 and a second film 340 also attached to the rigid wadding structure 330. In one disclosed embodiment, the rigid wadding structure 330 and first and/or second films may be made of homogeneous polyester terephthalate (PET) such that the entire structure enjoys recycling identification code number one. In order to construct a disclosed laminate system, the inner sides of the one or two film strips may comprise amorphous (non-crystalized) PET or other types or forms of PET. The amorphous sides or any side of a film strips may be heated and thus adhere to a first and/or second side of the wadding.

This method of using amorphous (non-crystalized) PET or any other types or configurations of PET to thermally bond a film strip to the wadding overcomes shortfalls in the prior art in that the disclosed method of attachment keeps the overall structure within the chemical boundaries of resin recycling identification code number “1” as no impurities are introduced. The disclosed use of amorphous (non-crystalized) PET upon the inner sides of the film strips allows for a relatively lower melting temperature to thermally bond the strips to the rigid wadding so as to not compromise the structural integrity of the rigid wadding. The chemical boundaries defining a recycling identification code number “1” may include the use of pure PET only.

The resulting disclosed structure may be manufactured in continuous sheets wherein low heat is applied to thermally bond the film strips to the upper and lower sides of the rigid wadding. The disclosed use and attachment of film to the rigid wadding overcomes shortfalls in the art by providing a protective film upon the rigid wadding to prevent fraying and other frictional damage to the rigid wadding. The disclosed application of film to the rigid wadding overcomes shortfalls in the art by providing smooth outward surfaces such that the insulation sheets may be slideably stacked and unstacked without snags or undue friction.

A rigid wadding system or other insulation system may comprise thermoplastic with binder fiber; powder binders and PLA. A first or second film attached to a wadding may be thermally attached by use of heat, the heat in the range of 200 to 400 degrees.

Disclosed embodiments may use starch adhesives, craft paper, bio resin, sugar cane or corn starch.

Disclosed embodiments include the use of corrugated cardboard sometimes covered in craft paper with the pulp of said components comprising repulpable biodegradable and sometimes embedded with seeds. Disclosed embodiments include a balancing of pH so as to optimize the growth of seeds imbedded into the paper or other shipping materials. Such pH may be in the range of 3 to 8 pH.

The definition of “pure PET” may include the presence of de minimus substances inadvertently introduced during a manufacturing process.

What is claimed is:

1. A laminate system of insulation material made of pure polyethylene terephthalate (“PET”), the laminate system comprising:
a first film made of pure PET;
a wadding made of pure PET;
wherein the wadding is fastened to the first film.

2. The laminate system of claim 1 wherein the wadding is fastened to the first film by use of heat.

3. The laminate system of claim 1 wherein the first film is made of pure PET only.

4. The laminate system of claim 1 wherein the wadding is made of pure PET only.

5. The laminate system of claim 2 wherein the heat used to fasten the first film to the wadding is in the range of 200 to 400 degrees.

6. The laminate system of claim 1 wherein the first film comprises a side with amorphous PET facing the wadding.

7. The laminate system of claim 1 further comprising a second film of pure PET fastened to the wadding.

8. The laminate system of claim 6 wherein the wadding is fastened to the first film by adhering to (1) the side of the first film comprising the amorphous PET.

9. The laminate system of claim 8, wherein the amorphous PET from the side of the first film is thermally bonded to the wadding without compromising structural integrity of the wadding.
